(19) United States
(12) Patent Application Publication
(10) Pub. No.: US 2003/0012303 A1
(43) Pub. Date: Jan. 16, 2003

(54) Method and apparatus for optimizing a PRML data-receiving channel for data-storage systems

(75) Inventors: Angelo Dati, (US); Cecilia Tonci, (US); Paolo Gaducci, (US)

Correspondence Address: GRAYBEAL JACKSON HALEY LLP, Suite. 350, 155-108th Avenue N.E., Bellevue, WA, 98004-5901, US

(73) Assignee: STMicroelectronics S.r.I.

(21) Appl. No.: 10/159,773

(22) Filed: May 31, 2002

(30) Foreign Application Priority Data
May 31, 2001 (EP) 01830358.6

(51) Int. Cl. H04L 27/22; H04L 27/14; H04L 27/06

(52) U.S. Cl. 375/316

(57) ABSTRACT

A method is provided for optimizing a PRML (Partial Response Maximum Likelihood) receiving channel for mass memory data receiving systems comprising an input receiving channel, a receiver placed downstream of the channel, a detector connected in cascade to the receiver, and a summing node being input both the receiver output through a delay line, and the output from the detector through an impulsive filter. The method includes performing an indirect estimate of the noise strength by filtering out the error sequence, i.e. the output signal from the summing node, through a filter, and selecting either the output from the summing node or the output from the filter to obtain an optimization parameter for feedback to the receiving system.

### TECHNICAL FIELD

The present invention relates generally to a method of optimizing a PRML (Partial Response Maximum Likelihood) data receiving channel, for mass memory data storage systems.

The invention relates more particularly, but not exclusively, to a method of optimizing the performance of a data receiving system comprising an input receiving channel, a receiver placed downstream of the channel, and a detector connected in cascade to the receiver.

The invention further relates to a data receiving system comprising an input receiving channel, a receiver placed downstream of the channel, and a detector connected in cascade to the receiver.

### BACKGROUND ART

Briefly, an embodiment of the invention relates to a method of indirectly measuring and optimizing the performance of a data receiving system, such as the system schematically shown in FIG. 1 of the drawings.

Systems of this kind require that a step of optimizing a PRML receiving channel be carried out automatically in order to have the receiving system equalised. To achieve this aim, a reference value representing the channel quality is necessary, which value is usually found by measuring either a bit error rate or a byte error rate.

Unfortunately, this measurement is often difficult to obtain at the calibration stage, and accordingly, measuring the reference value directly can hardly represent a workable basis for a method of automatically optimizing the system equalisation parameters.

FIG. 1 shows a view in schematic block form of a data receiving system 1 that comprises a partly conventional receiving channel 2, a receiver 3 connected downstream of the channel 2, and a detector 4 connected in cascade to the receiver 3.

The input signal to the system 1 is directly applied to one end of the channel 2, while the output signal is provided at the output 5 of the detector 4. The receiver 3 is to identify the channel 2 by an equalization operation, which is adaptative to programmable parameters and compensates for non-linear distortion.

A prior technique commonly used provides for an estimate of the noise strength p(D) on the signal to be taken at the output of the receiver 3 of the system 1, i.e. at the input of the detector 4.

In a condition of optimum performance, this estimate accounts just for the input noise to the channel 2, and can only be increased by a less-than-optimum calibration of the signal conditioning system. This prior technique combines simplicity with the practical character of an extremely direct circuit approach, since the received signal can be estimated, as needed to provide an estimate of the noise, by a simple threshold decision, as schematically shown in FIG. 2.

FIG. 2 schematically shows that the output from the receiver 3 branches off at the input to a threshold detector 6 as well as to a summing node 7 that also receives the inverted-sign output from the threshold decider 6. The result of the sum operation performed at the node 7 is an error sequence e(D), which is applied to a cascade of a multiplier block 8 and an accumulator block 9 to give a value ACCout for use as an optimization parameter in the receiving system 1.

Although the value provided by this technique does lie within the optimum range of the parameters, it is wholly ineffective for the purpose of the system final optimization because, in general, it is not adequately correlated with the error rate.

A second prior approach, also commonly used and being an improvement on the above method, consists of analysing certain metric measurements accumulated in a Viterbi detector. These metric measurements are representative of the estimate of the noise strength that is associated with the sequence decoded by the detector 4 in the system 1.

The use of metric measurements is also beneficial on many counts, such as the fact that they are computed already during normal operation of the detector 4. However, metric measurements generally cannot be used directly in systems that push the state of the art, i.e. in systems having a high integration density, without affecting the system speed.

Furthermore, with standard techniques for normalising the detector metric measurements, the measure value of noise strength associated with the decoded sequence is only indirectly available.

To obtain an indirect estimate of noise strength, the technique schematically shown in FIG. 3, and described here below, could be used.

The output of the receiver 3 is branched off to a delay line 10, and through the latter, to a summing node 11. The node 11 also receives the inverted-sign output from a filter 12 having an impulsive response p(D). The input of the filter 12 receives the branched output from the detector 4.

The result of the sum determined in the summing node 11 is an error sequence e(D), which is analysed in the same manner as in the prior art embodiment previously discussed in relation to FIG. 2.

But this approach has a drawback of its own in that it requires additional logic. Specifically, the logic blocks added here are the filter 12 with impulsive response p(D), for reconstructing the input signal to the detector 4, and the delay line 10 for compensating the latency of detector 4.

In addition, the state-of-art measuring methods discussed hereinabove, although in many ways advantageous, are not quite successful in providing an accurate estimate of the quality of the data receiving channel for the purpose of optimizing the receiving system performance.

### SUMMARY OF THE INVENTION

Consequently, an embodiment of this invention provides a novel method of assessing the performance of a receiving system, which method is appropriate to allow optimization of the PRML (Partial Response Maximum Likelihood) receiving channel and is particularly useful with mass memory data storage systems.

One principle on which this invention stands is to effect a selection of the error sequence to be used to obtain the optimization parameter of the system. In some situations, the output error sequence from the summing node is used, while in other situations a suitably filtered error sequence is selected.

### BRIEF DESCRIPTION OF THE DRAWINGS

The features and advantages of the method and the system according to the invention will be apparent from the following description of embodiments thereof, given by way of non-limiting examples with reference to the accompanying drawings.

FIG. 1 is a schematic block diagram of a data receiving system according to the prior art.

FIG. 2 is a schematic block diagram of a portion of the receiving system of FIG. 1, which incorporates functional blocks adapted to determine optimization parameters of the receiving system according to one technique.

FIG. 3 is a schematic block diagram of another version of the functional portion of FIG. 2, which incorporates functional blocks adapted to determine optimization paraments of the receiving system according to another technique.

FIG. 4 is a schematic block diagram of a data receiving system that incorporates an optimization functional portion in accordance with an embodiment of this invention.

FIGS. 5 and 6 are comparative graphs of the optimization parameters as respectively obtained with conventional systems and with the system of FIG. 4 for a given input value.

FIGS. 7 and 8 are comparative graphs of the optimization parameters as respectively obtained with conventional systems and with the system of FIG. 4 for another given input value.

### DETAILED DESCRIPTION OF THE INVENTION

The following discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

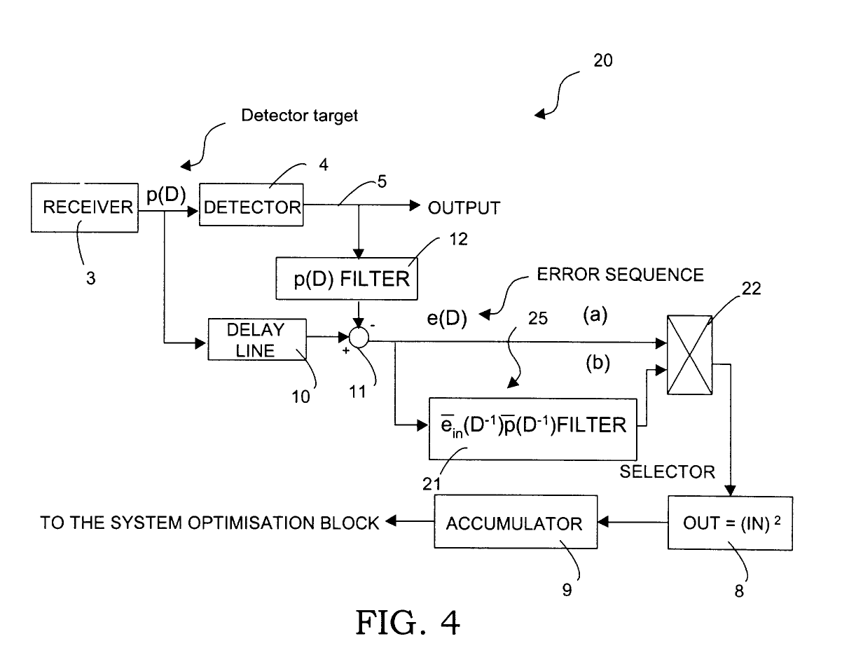

With reference to the drawings, in particular to the embodiment shown in FIG. 4, a data receiving system 20 is generally and schematically shown and incorporates a functional portion 25 for its optimization according to an embodiment of the invention.

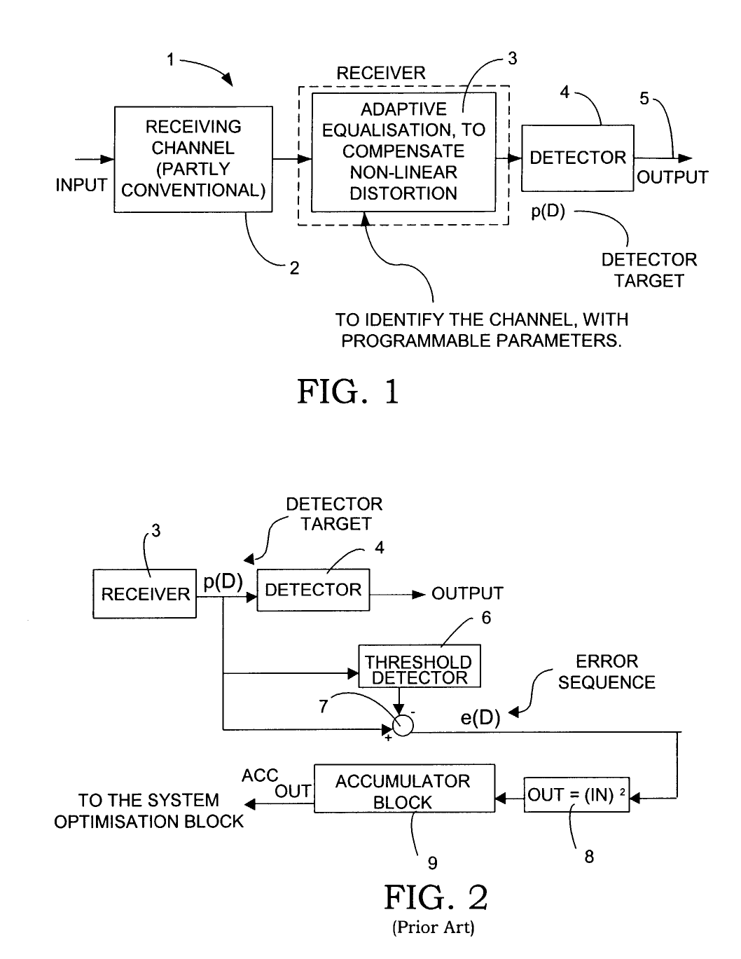

The same reference numerals will be used throughout to denote some particulars and parts function-wise equivalent to those of the conventional receiving system structure 1 previously described in relation to FIG. 1.

The data receiving system 20 also comprises a receiving channel 2 (FIG. 1)and a receiver 3 connected downstream of the channel 2, and a detector 4 being conventionally connected in cascade to the receiver 3.

The input signal is applied directly to one end of the channel 2 (FIG. 1), and the output signal is obtained from the output 5 of the detector 4.

The output of the receiver 3 is recognized as an estimate of strength of the signal noise at the detector 4 input.

The output of the receiver 3 branches off to the input of a delay line 10, whose output is applied to a summing node 11.

The output of the detector 4 branches off to a functional block 12, which block comprises an impulsive response filter p(D) for reconstructing the output sequence from the receiver 3 once the channel noise is filtered out.

The output from this block 12 is applied to the summing node 11, but with its sign inverted, such that a subtract operation is essentially performed in the node 11 of the receiver output, through the delay line 10, and the output from the detector 4, through the filter 12.

The output error sequence e(D) from the summing node 11 is routed along two separate paths: a first path that is applied directly to one input (a) of a multiplexer 22, and a second path that includes a filter 21 whose output is applied to another input (b) of the multiplexer 22.

The output from the selector 22 is applied to a cascade of a squaring block 8 and an accumulator block 9.

The squaring block 8 raises the received signal to a power of two. In other words, the output OUT from the block 8 equals the square (IN)² of the input signal IN.

Downstream of the squaring block 8, the accumulator block 9 provides a value ACCout, which is used as an optimization parameter for the receiving system 20 and is fed back to the system.

An estimate of the output ACCout from the accumulator 9 may be given as,

ACCout≅∥e∥²=∥x+n−x\∥²=∥err+n∥²

where x is the emitted signal sequence, n is the input noise to the detector 4, and x\ is an estimate of the signal sequence reconstructed by the detector.

The expression err=x−x\ indicates the error in the emitted sequence.

Proceeding from the above relation, and assuming the noise n to be on the average nil, it is,

∥err+n∥²=∥err∥²+∥n∥²

which brings out that the term tied to err is proportional to the error rate.

The described embodiments of the invention are aimed at improving the contribution of this term err, which, being consistent with the equalization aim at the detector input, can also be written as,

err(D)=p(D)eᵢₙ(D)

The described embodiments of this invention are based on an estimate of the following quantity:

\overline{p}(D⁻¹)\overline{e}ᵢₙ(D⁻¹)err(D)=\overline{p}(D⁻¹)p(D)\overline{e}ᵢₙ(D⁻¹)\overline{e}ᵢₙ(D)

which requires ACCout to be estimated as follows:

ACCout=∥\overline{p} [symbol] \overline{e}ᵢₙ [symbol] err∥²+∥\overline{p} [symbol] \overline{e}ᵢₙ [symbol] n∥²

If \overline{p(D)} and p(D) are the same expression, and the estimate of the error type \overline{eᵢₙ} is actually coincident with the error eᵢₙ due to the detector 4, then the estimate of the accumulator 9 will be based on the output of the filter 21 matched to 21 to the error err(D), which in the event of blank noise ensures the highest ratio for the quantity:

$$\frac{{‖ \overline{p} ⊗ {\overline{e}}_{i n} ⊗ err ‖}^{2}}{{‖ \overline{p} ⊗ {\overline{e}}_{i n} ⊗ n ‖}^{2}}$$

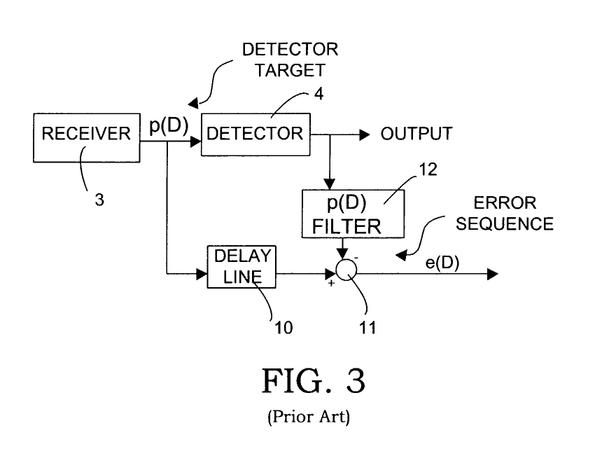

The modification made to the receiving system 1 of FIG. 3 is that discussed in relation to FIG. 4, wherein the same measuring capability as in the conventional system shown in FIG. 3 is retained, but with the important difference that the inputs (a) and (b) to the squaring block can now be selected. The possibility of varying the polynomial \overline{p(D)} of the impulsive response of the error from the filter 21 with respect to the estimate p(D), being the target for the detector 4, has been introduced to account for that the noise is generally correlated.

This optimization method has important practical effects when applied to optimizing the boost of an anti-aliasing low-pass filter used in the equalization chain of the signal of a read/write channel for mass memories, e.g. a hard disk drive.

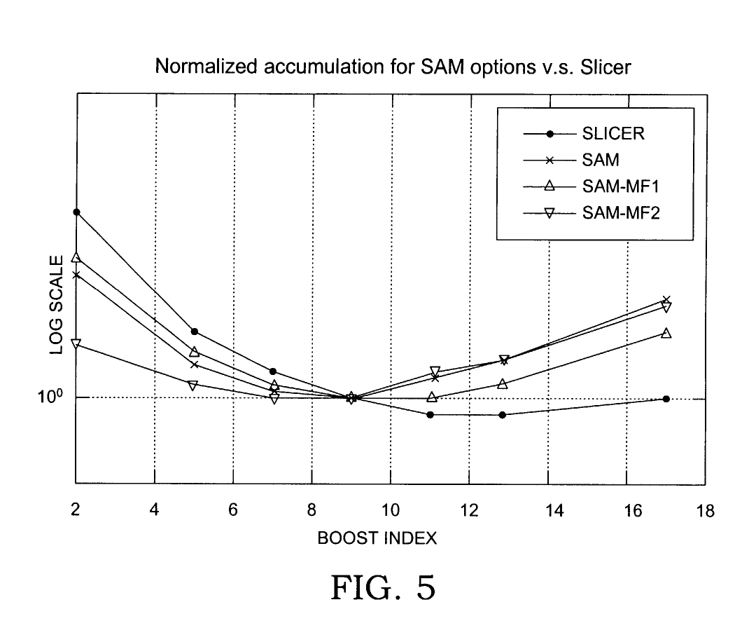

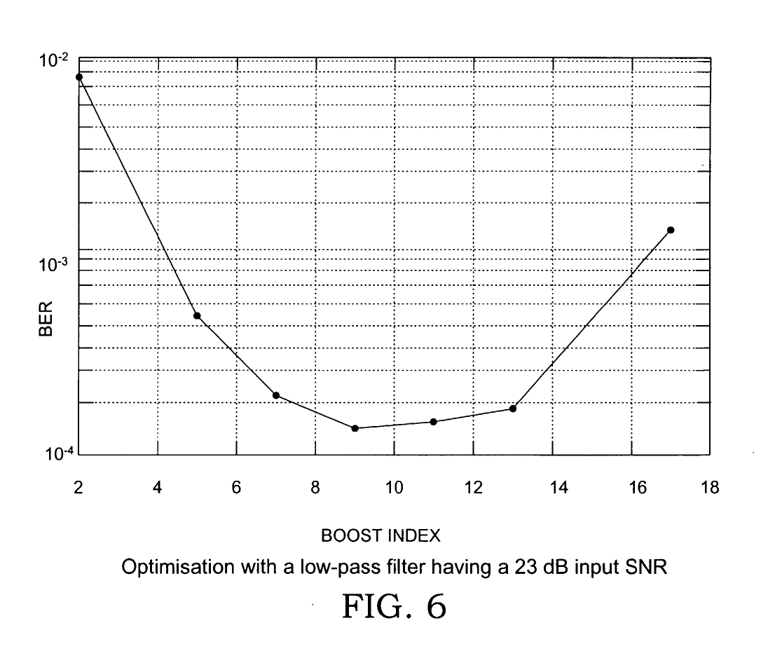

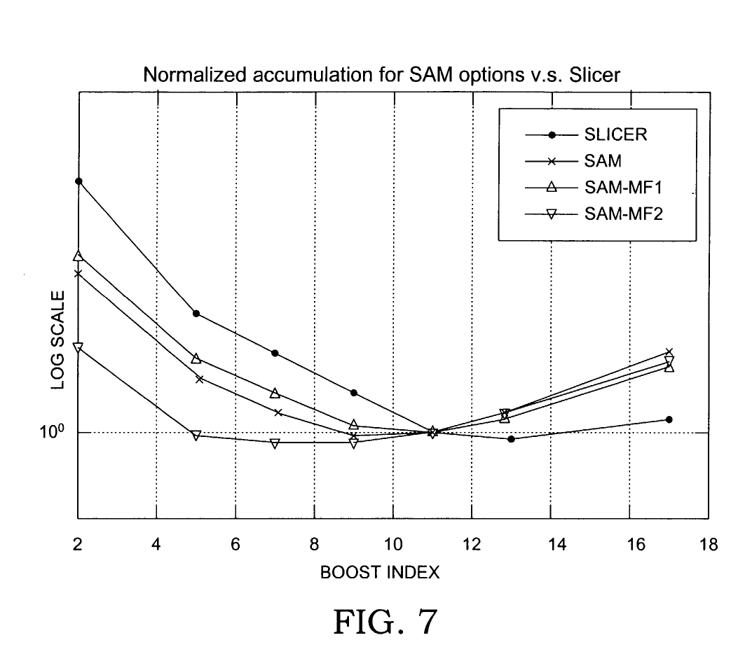

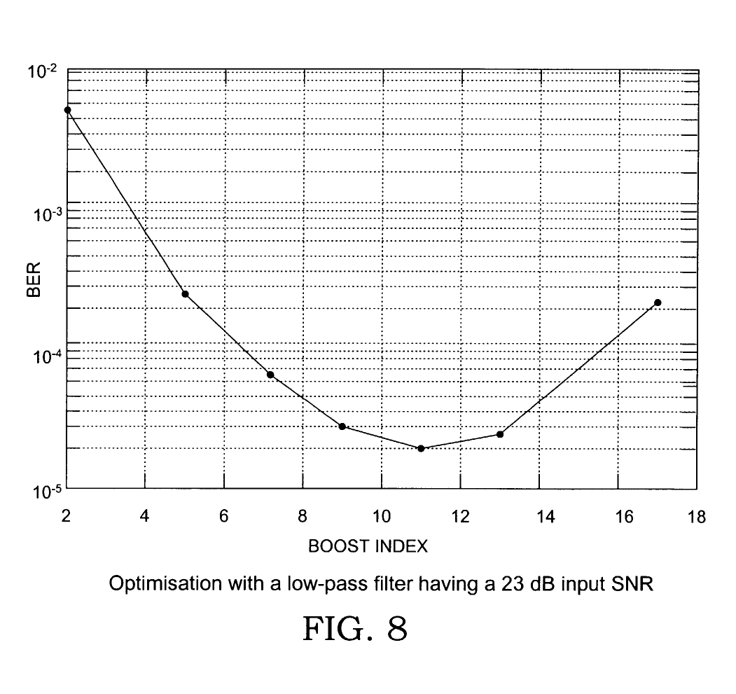

Shown in FIGS. 5 and 6 are comparative graphs of conventional solutions and the solution according to an embodiment of this invention.

More particularly, the graph of FIG. 5 is a comparative log scale plot of boosts for conventional systems and the system of FIG. 4. The graph of FIG. 6 is a BER (Byte Error Rate) scale plot of boost for a low-pass filter having a 23 dB input SNR.

The reference word “slicer” used in the graphs denotes the results of the conventional optimization technique shown in FIG. 2. A reference “SAM” denotes instead the results of the optimization, which is based on an examination of the detector metrics or, equivalently, an evaluation for selecting the input (a) of the multiplexer 22 (FIG. 4).

The reference numerals SAM_MF1 and SAM_MF2 denote the measured values for selecting the input (b) of the multiplexer 22 (FIG. 4), as obtained with two different filters \overline{e(D)}.

It matters to observe that the estimate SAM_MF1 is always minimal at the value that optimizes the error rate and at a high SNR. The value SAM_MF2 provides instead the right result only at lower SNRs. Notice that the system built around the threshold detector 6 of FIG. 2 can only recognize a range of optimum values. But it can be safely concluded that a reliable indication of the error rate can be obtained with the system 20 of FIG. 4.

An application of the method and the system 20 according to an embodiment of this invention to a PRML channel will now be described in detail.

The method of indirectly measuring the performance of the PRML channel and, accordingly, optimizing the parameters of the data receiving system, allows a calibration of the read/write system parameters for a data-storage system of the hard-disk-drive type to be performed more quickly at the first disk initialization stage.

In a hard-disk-drive type of mass-memory system, an analog signal is returned with characteristics that vary with the manufacturing tolerances of the magnetic medium, the read/write head, design peculiarities of the electronic circuitry in individual constructions, and unavoidable process spread.

Currently manufactured hard disks are applied a “zoning” technique, whereby a hard disk is divided into zones to be differently written in, so as to increase the density of the recorded information in the magnetic medium. However, this technique involves a number of calibration steps for a single surface. Assuming, as an example, three zones per surface and a plain disk with one plate, 3×2=6 separate calibrations of the hard disk drive would be necessary.

The parameters to which the signal is tied, moreover, interlink in a manner that cannot be expressed by any functional relation, and the parameter of primary interest to the user, i.e. error rate, is the more laborious parameter to have measured.

Thus, one could apply an exhaustive scanning of the whole set of the possible hard-disk-system configurations on each unit produced by the hard-disk-drive manufacturer, until the optimum set-up for each zone of each surface is found.

To save time in testing and optimizing each drive, the manufacturer takes a short cut that presupposes an estimate of a correlated quantity with the error rate, and that allows an indirect estimate to be obtained.

Such stratagems, discussed above in connection with the prior art of FIGS. 1-3, result in the testing time being dramatically reduced—since it could be thought of validating the optimum setup by reading a few tens of sectors, rather than the several thousands that are needed for a reliably estimated error rate.

Without the technique described above in conjunction with FIG. 4, however, indirect estimates are only partially successful because, as illustrated by the system 20 of FIG. 4, the estimates bear no proven relation to the error rate. On the other hand, the straightforward processing described hereinabove allows a reliable and quick optimization to be achieved at once with an implementing effort that is only a fraction of that required for implementing the detector alone.

To summarize, a method according to an embodiment of the invention is advantageous over prior solutions, in that it allows the system byte error rate (BER) to be minimized within a much shorter time than by a direct measurement of the BER.

All the complexity that is added to the system circuit-wise amounts to providing one or more filters adapted to the most likely system errors. Also, this method is not invasive of the detector structure and leaves speed performance unaffected.

Thus, the system 20 of FIG. 4 invention provides a reliable method of optimizing the data receiving system parameters, especially in PRML channel read/write applications for hard-disk drives, using matched filters to the estimated output noise from the signal processing system.

From the foregoing it will be appreciated that, although specific embodiments of the invention have been described herein for purposes of illustration, various modifications may be made without deviating from the spirit and scope of the invention.

We claim:

1. An optimization circuit for a data-receiving circuit that includes a data receiver for generating a data signal and a data detector for recovering data from the data signal, the optimization circuit comprising:
a first filter coupled to the data detector and operable to reconstruct the data signal from the recovered data;
a delay circuit coupled to the data receiver and operable to delay the data signal;
a combiner coupled to the first filter and to the delay circuit operable to determine the difference between the reconstructed and delayed data signals;
a second filter coupled to the combiner and operable to filter the difference between the reconstructed and delayed data signals; and
a generator coupled to the combiner and to the second filter and operable to generate an optimization parameter from either the difference or the filtered difference.

2. The optimization circuit of claim 1 wherein the generator comprises:
a multiplexer coupled to the combiner and to the second filter and operable to select as an error signal the difference between the reconstructed and delayed data signals or the filtered difference;
a multiplier coupled to the multiplexer and operable to square the error signal; and
an accumulator operable to generate the optimization parameter from the squared error signal.

3. The optimization circuit of claim 1 wherein the generator is operable to generate a first optimization parameter from the difference between the reconstructed and delayed data signals and a second optimization parameter from the filtered difference between the reconstructed and delayed data signals.

4. A method, comprising:
reconstructing a data signal from data recovered from the data signal;
calculating a difference between the reconstructed data signal and a delayed version of the data signal;
filtering the difference; and
generating an optimization parameter from either the difference or the filtered difference.

5. The method of claim 1 wherein:
the data signal includes data samples; and
generating the optimization parameter comprises:
selecting as an error signal the difference or the filtered difference,
squaring the error signal,
accumulating the squared error signal over a number of samples of the data signal, and
generating the optimization parameter from the accumulated squared error signal.

6. The method of claim 3 wherein generating the optimization parameter comprises:
generating a first optimization parameter from the difference; and
generating a second optimization parameter from the filtered difference.

7. A method of optimizing a PRML (Partial Response Maximum Likelihood) receiving channel for mass memory data receiving systems comprising an input receiving channel, a receiver placed downstream of the channel, a detector connected in cascade to the receiver, and a summing node being input both the receiver output through a delay line, and the output from the detector through an impulsive filter, the method being characterized by:
performing an indirect estimate of the noise strength by filtering out the error sequence, i.e. the output signal from said summing node, through a filter; and
selecting either the output from the summing node or the output from said filter to obtain an optimization parameter (ACCout) for feedback to the receiving system.

8. A method according to claim 7, characterized in that the selecting step is carried out in a multiplexer connected in downstream of both the node and the filter.

9. A data receiving system, comprising an input receiving channel, a receiver placed downstream of the channel, a detector connected in cascade to the receiver, and a summing node being input both the receiver output through a delay line, and the output from the detector through an impulsive filter, characterized in that it further comprises a multiplexer receiving, on a first input, the output from said summing node, and on a second input, the same output from the summing node through a filter.

10. A data receiving system according to claim 9, characterized in that said selector has an output connected to a cascade of a squaring block and an accumulator block.

11. A data receiving system according to claim 10, characterized in that said squaring block effects a squaring of the input signal.

12. A data receiving system according to claim 10, characterized in that said accumulator block outputs a parameter value for use in optimizing the receiving system.
